(19) United States
(12) Patent Application Publication
(10) Pub. No.: US 2013/0218395 A1
(43) Pub. Date: Aug. 22, 2013

(54) AUTONOMOUS MOVING APPARATUS AND METHOD FOR CONTROLLING THE SAME

(71) Applicants: Hyun Kim, Daejeon (KR); Kang Woo Lee, Daejeon (KR); Hyoung sun Kim, Daejeon (KR); Young Ho SUH, Gwangju (KR); Joo Chan SOHN, Daejeon (KR)

(72) Inventors: Hyun Kim, Daejeon (KR); Kang Woo Lee, Daejeon (KR); Hyoung sun Kim, Daejeon (KR); Young Ho SUH, Gwangju (KR); Joo Chan SOHN, Daejeon (KR)

(73) Assignee: ELECTRONICS AND TELECOMMUNICATIONS RESEARCH INSTITUTE, Daejeon (KR)

(21) Appl. No.: 13/595,346

(22) Filed: Aug. 27, 2012

(30) Foreign Application Priority Data
Feb. 22, 2012 (KR) 10-2012-0018071

(51) Int. Cl. G05D 1/02

(52) U.S. Cl. 701/23

(57) ABSTRACT

Disclosed are a mobile apparatus and a method for controlling the same. More particularly, disclosed are an autonomous mobile apparatus and a method for controlling the same. The method for controlling an autonomous mobile apparatus disclosed in the specification includes: recognizing a direction of a call signal based on the call signal; receiving and analyzing video information regarding the direction; estimating a position of a signal source of the call signal using the sound source localization and the detected person's shape; generating a moving command to the position of the signal source; and recognizing the subject of the signal source after movement according to the moving command.

### CROSS-REFERENCE TO RELATED APPLICATIONS

This application claims priority to and the benefit of Korean Patent Application No. 10-2012-0018071 filed in the Korean Intellectual Property Office on Feb. 22, 2012, the entire contents of which are incorporated herein by reference.

### TECHNICAL FIELD

The present invention relates to a mobile apparatus and a method for controlling the same. More particularly, the present invention relates an autonomous mobile apparatus and a method for controlling the same.

### BACKGROUND ART

Recently, various types of intelligent robots have been developed. In order for an intelligent robot to provide services to a user, first, when a user wanting to use a robot calls the robot, the robot searches the calling user and moves toward the user.

Since 1980, research and development for efficiently autonomous navigation have been actively conducted for each application, such as a robot, a car, and the like. An autonomous navigation technology is largely classified into a localization technology accurately searching a current position of a robot, a map building technology detecting environment or a space, and a path planning technology capable of safely performing movement by generating a moving path. Meanwhile, various methods have been proposed for each application.

Simultaneous localization and mapping (SLAM) simultaneously considering the localization and the map building has been proposed in 1989. Recently, a concept of integrated approach mechanisms simultaneously considering the SLAM and the autonomous navigation has been proposed. However, an integrated algorithm capable of being applied to general environment and securing economical efficiency is not proposed. Most of proposed results can be applied only to special environment or correspond to experimental results using expensive sensors.

An example of the algorithms developed until now may include an SLAM algorithm that can simultaneously perform the localization and the map building in indoor environment by using a laser sensor. The SLAM algorithm is very accurate since a position error is about 2 cm even at the time of navigating a distance of about 100 m, but has a disadvantage of using an expensive laser sensor.

Another algorithm may include a map building algorithm for a circulation section using a global map by using the laser sensor. However, the map building algorithm uses the expensive laser sensor and does not allow extendibility when there are a very large number of circulation sections.

Meanwhile, an algorithm capable of simultaneously performing the localization and the map building by only using 16 ultrasonic sensors has been proposed, which can be applied to only the environment in which the surroundings are configured of a straight line.

As a result, various researches in the related fields cannot be easily commercialized due to the use of expensive sensors, can be applied only to a specific environment, or presents only detailed technologies and therefore, cannot be easily applied in the integrated type.

### SUMMARY OF THE INVENTION

The present invention has been made in an effort to an apparatus and a method for calling and using a robot at any time when a user wants to use a robot while satisfying economical efficiency (a use of inexpensive robot) and integrity (a circulation method of localization and movement) so as to use a robot in the real environment.

An exemplary embodiment of the present invention provides a method for controlling an autonomous mobile apparatus, including: recognizing a direction of a call signal based on the call signal; receiving and analyzing video information regarding the direction; estimating a position of a signal source of the call signal using the sound source localization and the detected person's shape; generating a moving command to the position of the signal source; and recognizing the subject of the signal source after movement according to the moving command.

Another exemplary embodiment of the present invention provides an autonomous mobile apparatus, including: a sensor module configured to sense a call signal and video information; a navigation module configured to include a driver; and a controller configured to control the navigation module based on the sensor module, in which the controller includes: an analyzer configured to recognize a direction of the call signal based on the input call signal and receive and analyze video information regarding the direction; an estimator configured to estimate a position of a signal source of the call signal using the sound source localization and the detected person's shape; and a navigation controller configured to generate the moving command to the estimated position of the signal source to generate the navigation module, and wherein the analyzer recognizes the subject of the signal source by using the camera sensor module after movement according to the moving command.

According to the exemplary embodiments of the present invention, it is possible to call and use the robot at any time when the user wants to use the robot while satisfying the economical efficiency and the integrity so as to use the robot in the real environment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram for describing a method for controlling an autonomous mobile apparatus disclosed in the specification.

FIG. 2 is a diagram for describing an autonomous mobile apparatus disclosed in the specification.

FIG. 3 is a diagram for describing a hardware configuration of an intelligent mobile robot according to an exemplary embodiment of the present invention.

FIG. 4 is a diagram for describing a system software configuration of an intelligent mobile robot according to an exemplary embodiment of the present invention.

FIG. 5 is a diagram for describing a procedure of a task operation in a task system described in FIG. 4.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Only a principle of the present invention will be described below. Therefore, although the principle of the present invention is not clearly described or shown in the specification, those skilled in the art can implement a principle of the present invention and invent various apparatuses included in a concept and a scope of the present invention. In addition, conditional terms and embodiments described in the specification are in principle used only for purposes for understanding the concept of the present invention and are to be construed as being not limited to specifically described embodiments and states.

In addition, principles, aspects, and embodiments of the present invention and all the detailed descriptions describing specific embodiments are to be construed as including structural and functional equivalents of the above description. Further, these equivalents are to be construed as including known equivalents known until now and equivalents to be developed in the future, that is, all the elements invented to perform the same functions independent of the structure.

Accordingly, for example, a block diagram in the specification is to be construed as indicating a conceptual aspect embodying the principles of the present invention. Similarly, it is to be noted that all the flow charts, status conversion diagram, pseudo code, and the like, may be substantially represented in a computer readable medium and represent various processes executed by a computer or a processor independent of whether the computer or the processor is shown in the drawings.

A function of a processor or various elements shown in the drawings including functional blocks represented as a concept similar thereto may be provided by using dedicated hardware and hardware with ability executing software in connection with appropriate software. When the functions are provided by the processor, the functions may be provided by a single dedicated processor, a single sharing processor, or a plurality of individual processor and some thereof can be shared.

In addition, terms presented as processor, control, or a concept similar thereto are not construed as exclusively including hardware having ability executing software and are to be construed as implicitly including digital signal processor (DSP) hardware and ROM, RAM, and non-volatile memory for storing software. Widely known other hardware may also be included.

Components represented as means for executing a function described claims and the detailed description of the present specification are to be construed as including all the methods executing functions including a combination of circuit elements performing the above functions or all the types of software including firmware/micro code, and the like and are combined with appropriate circuits for executing the software so as to perform the functions. Since the present invention defined by claims is combined with functions provided by various described means and with methods described in claims, any means providing the above functions is to be construed as being equivalent to ones understood from the present specification.

The foregoing objects, features and advantages will become more apparent from the following description of preferred embodiments of the present invention with reference to accompanying drawings, which are set forth hereinafter. Accordingly, those having ordinary knowledge in the related art to which the present invention pertains will easily embody technical ideas or spirit of the present invention. Further, when technical configurations known in the related art are considered to make the contents obscure in the present invention, the detailed description thereof will be omitted.

Hereinafter, exemplary embodiments of the present invention will be described in detail with reference to the accompanying drawings.

The present specification discloses an autonomous mobile apparatus and a method for controlling the same. More specifically, the autonomous mobile apparatus recognizes directions by responding to an external call and detects a subject of a call, thereby estimating a position of the subject of the call and moving to the corresponding position to recognize the subject of the call again.

Herein, a mobile apparatus in the autonomous mobile apparatus means an apparatus including a driver for moving a car, a robot, and the like, and may be variously implemented according to the purpose.

Hereinafter, the mobile apparatus will be described in detail with reference to the accompanying drawings.

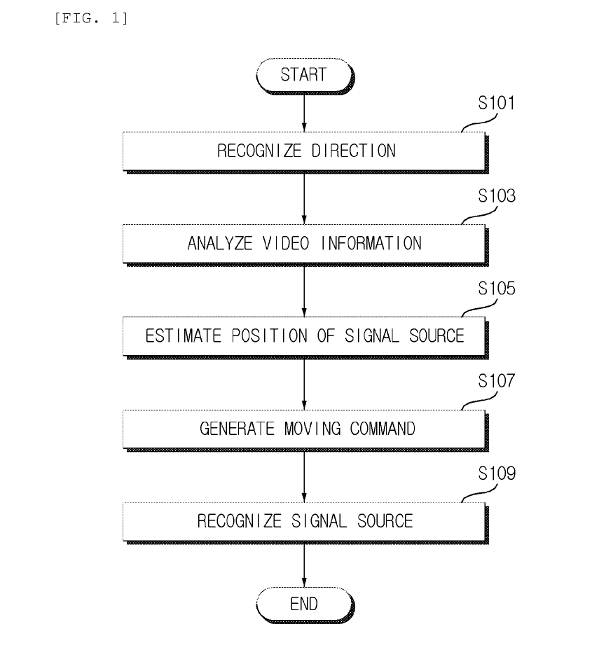

FIG. 1 is a diagram for describing a method for controlling an autonomous mobile apparatus disclosed in the specification.

When a call signal for an autonomous mobile apparatus is generated from the outside, the autonomous mobile apparatus receives the call signal. In this case, a method for controlling the autonomous mobile apparatus includes: recognizing a direction of the call signal based on the input call signal (S101); receiving and analyzing video information regarding the direction (S103); estimating a position of a signal source (a subject of the call) of the call signal using the sound source localization and the detected person's shape (S105); generating a moving command to the position of the signal source (S107); and recognizing the subject of the signal source after moving according to the moving command (S109).

Here, the call signal may include a human voice signal. However, the call signal is not limited thereto. The call signal is to detect the direction (or position) of the subject of the call and may be implemented as light or a radio signal in addition to a sound signal (including sound signals in addition to a sound signal relating to a human voice) according to the application.

The recognizing (S101) may include recognizing, by an analyzer 221, a voice signal. In the case of recognizing the voice signal, a call sound and a call direction can be recognized. while the call sound may use a method for recognizing a human voice, the call direction may use a method for localizing a sound source using 4 channel microphone.

The recognizing of the call sound (S109) may include generating, by the analyzer 221, a signal corresponding to the recognized voice signal. For example, when a person calls the autonomous mobile apparatus using the human voice, the autonomous mobile apparatus detects the sound location, recognizes the human voice, moves around a person, queries the signal source (a caller) using the human language for recognizing a call, and analyzes human response to the query, thereby accurately recognizing the caller.

The analyzing (S103) may include analyzing, by the analyzer 221, the correspondence between the call signal and the video information regarding the direction. When receiving the call signal, the direction of the call is recognized, and when the video information of the corresponding direction is received, it is possible to determine whether the input call signal corresponds to the video signal. For example, even though the call signal is input through the human voice, it may be determined that the correspondence is not established if it is determined that the received video signal includes only objects or animals.

In the estimating (S105), an estimator 223 may perform estimation based on the call signal and the video information regarding the corresponding direction. The position of the signal source may be generally estimated based on a direction and a distance. The direction of the signal source may be estimated by the receiving direction of the call signal, and the position of the signal source may be estimated by calculating the distance using the call sound of the call signal and/or the video information. Meanwhile, in the estimating, the moving path may also be set by detecting obstacles between the autonomous mobile apparatus and the signal source by using the received video signal.

The generating of the moving command (S107) may include generating, by a navigation controller 225, a command changing a path based on an ultrasonic wave and/or a signal sensed by a bumper sensor. The ultrasonic sensor obtains the distance information to sense presence and absence of obstacles, and the bumper sensor recognizes obstacles by touch.

The recognizing of the signal source (S109) may include recognizing, by the analyzer 221, the signal source by receiving the video information from the signal source after moving according to the moving command. The position estimation in the estimating of the position (S105) as described above may be set as estimating a substantial position, and the signal source may be recognized by receiving the video information of the signal source again and analyzing the received video information after moving around the signal source.

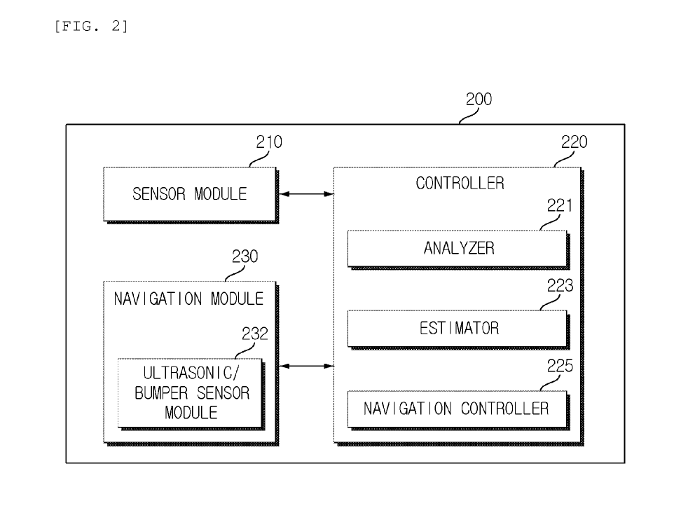

FIG. 2 is a diagram for describing an autonomous mobile apparatus disclosed in the specification. The autonomous mobile apparatus shown in FIG. 2 uses a method for controlling the autonomous mobile apparatus shown in FIG. 1.

Referring to FIG. 2, an autonomous mobile apparatus 200 includes a sensor module 210, a navigation module 230, and a controller 220.

The sensor module 210 senses the call signal and the video information. The sensor module 210 may include a microphone for sensing the call signal and a camera for sensing the video information.

The navigation module 230 includes a driver. In addition, the navigation module 230 may further include wheels, gears, and the like, for driving the autonomous mobile apparatus 200. The driver may include an electric motor and all the driving devices capable of implementing other movements such as an internal combustion engine, an external combustion engine, and the like, may be provided.

The controller 220 controls the navigation module based on the sensor module.

The controller 220 includes the analyzer 221 that recognizes the direction of the call signal based on the input call signal and receives and analyzes the video information regarding the direction, the estimator 223 that estimates the position of the signal source of the call signal, and the navigation controller 225 that generates the moving command to the position of the estimated signal source to control the navigation module.

In this configuration, the analyzer 221 recognizes the signal source by using the sensor module 210 after moving according to the moving command.

The call signal may include the voice signal, and the analyzer 221 may include a voice recognizing unit that recognizes the voice signal and image recognizing unit that recognizes the human's body shape or face.

Meanwhile, the controller 220 may further include a response generating unit that generates a signal corresponding to the recognized voice signal.

The analyzer 221 may includes a correspondence analyzer that analyzes the correspondence between the call signal and the video information regarding the direction.

The estimator 223 may perform the estimation based on the call signal and the video information regarding the direction.

The navigation module 230 may include an ultrasonic and/or bumper sensor module 213. In this case, the navigation controller 225 may control the navigation module 230 so as to change a path based on the signal sensed by the ultrasonic and/or bumper sensor module 231.

The analyzer 221 may receive the video information of the signal source after movement to recognize the signal source.

The other detailed description of the autonomous mobile apparatus 200 is the same as the description of FIG. 1 and therefore, the description thereof will be omitted.

Hereinafter, the detailed exemplary embodiments of the autonomous mobile apparatus and the method for controlling the same that are described in the specification will be described. Hereinafter, as an example of the autonomous mobile apparatus, an intelligent mobile robot will be described.

The intelligent mobile robot searches a caller when the call of the caller (user, that is, person) is issued and moves to the searched caller. In detail, the intelligent mobile robot recognizes a call sound and a call direction of a user to detect a person's shape, estimates a position of a user using the sound source localization and the detected person's shape, moves to a substantially estimated position, and then, again searches a person that is a caller through the user recognition.

In the exemplary embodiment of the present invention, the mobile robot having a simple navigation function so as to avoid only obstacles by using the ultrasonic sensor is configured to move to the position of the user calling the robot by using an inexpensive camera and a microphone.

Hereinafter, the mobile apparatus will be described in detail with reference to the accompanying drawings.

The robot described in the exemplary embodiment of the present invention is a mobile robot configured by a camera, a microphone, a mobile apparatus, and the like.

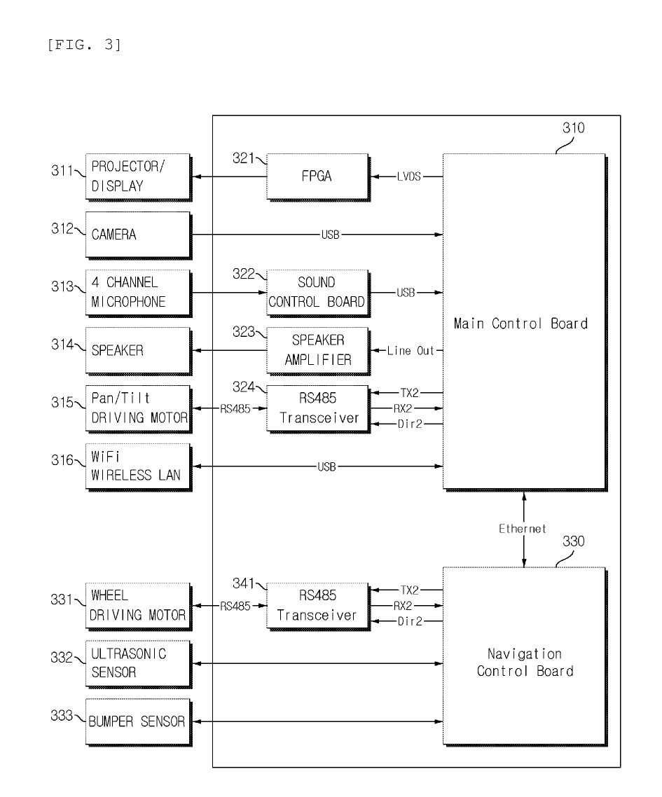

FIG. 3 is a diagram for describing a hardware configuration of an intelligent mobile robot according to an exemplary embodiment of the present invention.

Referring to FIG. 3, the intelligent mobile robot may be configured to include a main control board 310 and a navigation control board 330. The main control board 310, which serves to perform most processes, is connected to a camera 312, a Pin/Tilt driving motor 315, screen output devices, such as a display, a projector 311, and the like, a 4 channel microphone 313, a speaker 314, a wireless LAN (316), and the like, and controls these components and serves to drive programs executing actual tasks. The main control board 310 may be connected with the camera 312, the Pin/Tilt driving motor 315, the screen output devices such as the display, the projector 311, and the like, the 4 channel microphone 313, the speaker 314, the wireless LAN 316, and the like, by connection methods 321, 322, 323, 324, and the like, that meet each standard requirement.

A sound control board 322 may play a role of voice processing for voice recognition, synthesis, sound source tracing, and the like.

The navigation control board 330 serves to move a robot and is connected to an ultrasonic sensor 332, a bumper sensor 333, a wheel driving motor 331, and the like, and controls these components. The navigation control board 330 is also connected to the ultrasonic sensor 332, the bumper sensor 333, the wheel driving motor 331, and the like, by the connection methods 341 and the like, that meet each standard requirement.

Communication between the main control board 310 and the navigation control board 330 can be made through Ethernet. In some cases, the single main control board 310 may perform a role of the components of these boards 310, 330, 332, and the like, and an additional control board may also be used. For example, the main control board 310 may also play a role of the sound control board 322. On the other hand, a video processing board is separately configured to perform only the video processing.

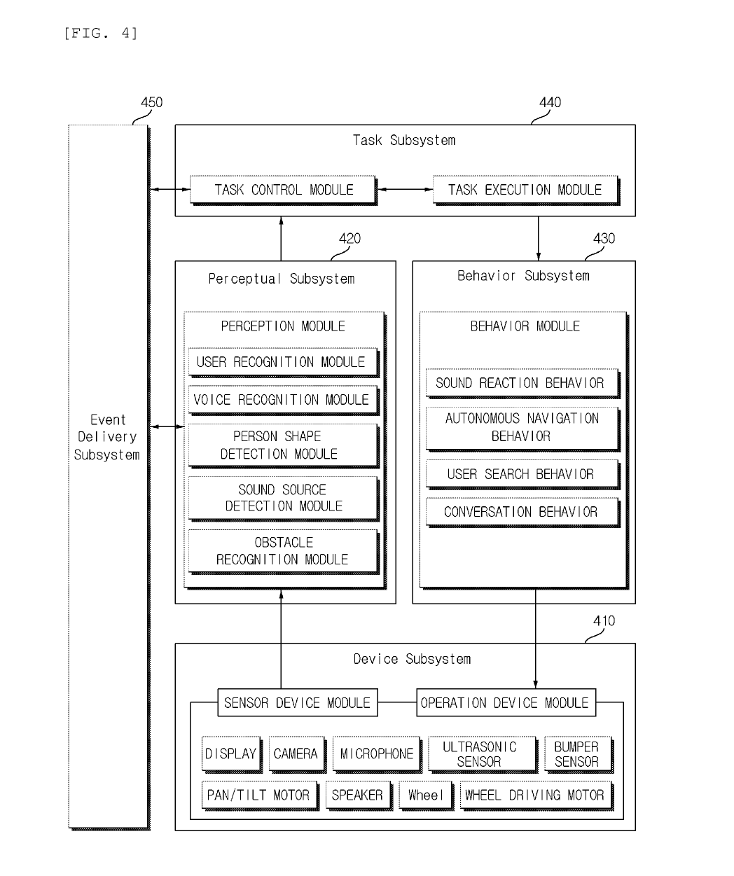

FIG. 4 is a diagram for describing a system software configuration of an intelligent mobile robot according to an exemplary embodiment of the present invention.

Referring to FIG. 4, a system may be configured to largely include five subsystems. In detail, the system is configured to include a device subsystem 410, a perception subsystem 420, a behavior subsystem 430, a task (execution) system 440, and an event delivery system 450.

First, the device subsystem 410 is configured of device modules that abstracts physical hardware devices including a sensor and an actuator of a robot into software logic devices. As shown in FIG. 4, the device subsystem 410 may include a sensor device module, a operation device module, and the like.

The perception subsystem 420 is configured of modules that percepts users and environment conditions based on information transmitted from the sensor device module. For example, the perception subsystem 420 recognizes where sound is generated (sound detection), what the user says, whether the user's say is a call word (voice recognition), and the like, from the voice information transferred from the microphone sensor. The perception system recognizes whether there is a person therearound (person shape detection), who the person is (user recognition), and the like, from the image information transferred from the camera sensor module. In addition, the perception system recognizes whether obstacles are present in front thereof by the distance information obtained from the ultrasonic sensor, whether the robot is bumped into the obstacles by the bumper sensor (obstacle perception), and the like.

The behavior subsystem 430 manages various unit behaviors of a robot and executes a requested unit behavior at the time of request in a task execution module. The behavior includes a behavior (sound reacting behavior) turning a user's head to a sound direction by responding to a call sound of a user, a behavior (autonomous traveling behavior) moving to a designated position while avoiding obstacles, a behavior (user search) searching the surrounding users, a behavior (conversation behavior) performing question and answer using TextToSpeech (TTS), and the like.

The task system 440 is a module to control and perform an operation of an entire system of a robot computer. In the exemplary embodiment of the present invention, the task corresponds to searching a caller and moving to the caller.

Finally, the event delivery subsystem 450 manages various events that are generated between all the subsystems and serves to transfer information through message exchange between respective system modules.

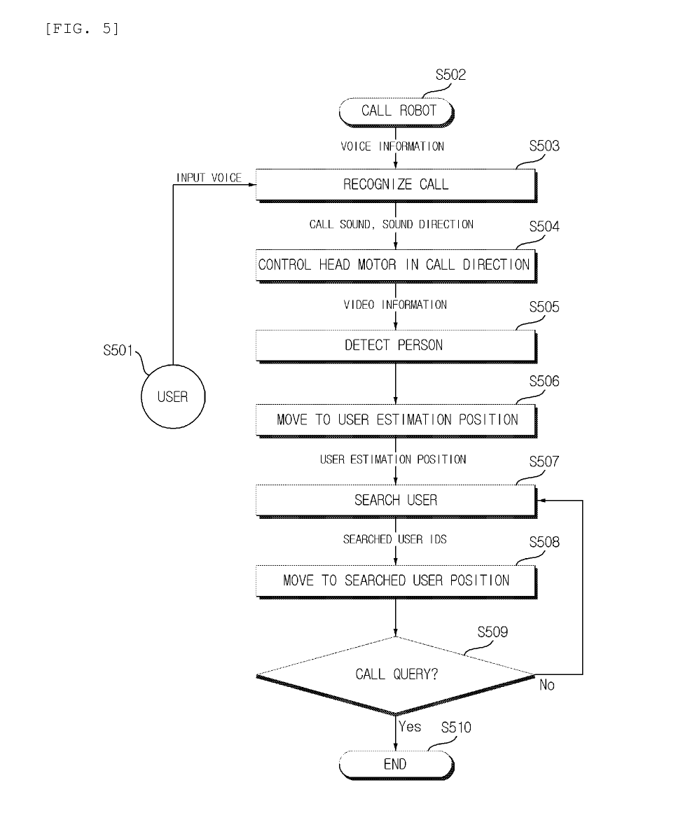

FIG. 5 is a diagram for describing a procedure of a work operation in a work system described in FIG. 4.

When the user (S501) calls the mobile robot (S502), the mobile robot receives the user's voice and recognizes whether a call is present using the received voice information (S503). The camera moves (or, rotates, directs) to the call direction based on the call sound and the sound direction for a call (S504). The camera may be mounted at a head or other components of the robot.

A person is detected from the video information input through the camera (S505) and the position of the user that is a caller is estimated. When the position of the user is estimated, the robot moves to the estimated position (S506) and then, again searches the user (S507). The search of the user (S507) may use a method of matching the pre-stored face or body shape images of the user with the input video information. Meanwhile, it is possible to previously confirm the user by matching the pre-stored voice pattern information of the user with the input call voice information at the time of the first call of the user.

Finally, the mobile robot moving to the user queries to the user whether the user issues a call (S509). The query may be output through the display or may also be output in voice. In connection with this, when the user gives a positive response, the corresponding procedure ends (S510), and when the user gives a negative response, the process is again repeated from the process of searching a user.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for controlling an autonomous mobile apparatus, comprising:
recognizing, by an analyzer, a direction of a call signal based on the call signal;
receiving and analyzing, by the analyzer, video information regarding the direction;
estimating, by an estimator, a position of a signal source of the call signal using the sound source localization and the detected person's shape;
generating, by a navigation controller, a moving command to the position of the signal source; and
recognizing, by the analyzer, the signal source after movement according to the moving command.

2. The method of claim 1, wherein the call signal includes a voice signal.

3. The method of claim 2, wherein the recognizing includes recognizing, by the analyzer, the voice signal.

4. The method of claim 3, wherein the recognizing of the signal source includes generating a signal corresponding to the recognized voice signal.

5. The method of claim 1, wherein in the analyzing, the analyzer analyzes correspondence between the call signal and the video information regarding the direction.

6. The method of claim 1, wherein in the estimating, the estimator performs estimation the call signal and the video information regarding the direction.

7. The method of claim 1, wherein the generating of the moving command includes generating, by a navigation controller, a command of changing a path based on a signal sensed by an ultrasonic and/or bumper sensor.

8. The method of claim 1, wherein the recognizing of the signal source includes receiving, by the analyzer, the video information of the signal source after the movement to recognize the signal source.

9. An autonomous mobile apparatus, comprising:
a sensor module configured to sense a call signal and video information;
a navigation module configured to include a driver; and
a controller configured to control the navigation module based on the sensor module,
wherein the controller includes:
an analyzer configured to recognize a direction of the call signal based on the input call signal and receive and analyze video information regarding the direction;
an estimator configured to estimate a position of a signal source of the call signal using the sound source localization and the detected person's shape; and
a navigation controller configured to generate the moving command to the estimated position of the signal source to generate the navigation module, and
wherein the analyzer recognizes the signal source by using the sensor module after movement according to the moving command.

10. The autonomous mobile apparatus of claim 9, wherein the call signal includes a voice signal.

11. The autonomous mobile apparatus of claim 10, wherein the analyzer includes a voice recognition unit that recognizes the voice signal.

12. The autonomous mobile apparatus of claim 11, wherein the controller further includes a response generating unit that generates a signal corresponding to the recognized voice signal.

13. The autonomous mobile apparatus of claim 9, wherein the analyzer includes a correspondence analyzer that analyzes correspondence between the call signal and the video information regarding the direction.

14. The autonomous mobile apparatus of claim 9, wherein the estimator performs estimation based on the call signal and the video information regarding the direction.

15. The autonomous mobile apparatus of claim 9, wherein the navigation controller includes an ultrasonic and/or bumper sensor module and controls the navigation module to change a path based on a signal sensed by the ultrasonic and/or bumper sensor module.

16. The autonomous mobile apparatus of claim 9, wherein the analyzer receives the video information of the signal source after the movement to recognize the signal source.
